(19) United States
(12) Patent Application Publication
(10) Pub. No.: US 2008/0179023 A1
(43) Pub. Date: Jul. 31, 2008

(54) Window covering device

(75) Inventor: Li-Ming Cheng, Kaohsiung (TW)

Correspondence Address: Joe McKinney Muncy, PO Box 1364, Fairfax, VA, 22038-1364, US

(73) Assignee: ZIPSHADE INDUSTRIAL (B.V.I.) CORP

(21) Appl. No.: 11/700,158

(22) Filed: Jan. 31, 2007

(51) Int. Cl. E06B 9/24

(52) U.S. Cl. 160/368.1

(57) ABSTRACT

A window covering device includes a top rail, a middle rail, and a bottom rail. A window covering is connected to the middle rail and the bottom rail. Multiple roller groups are mounted in the top rail. Two cord controllers are mounted on the top rail, as well as two cord groups. Each cord group includes inner cords and outer cords. One of the inner cords winds the rollers and is mounted on the middle rail through the top rail and the other inner cord winds the rollers and is mounted on the bottom rail through the top rail, the middle rail and the blind. The top rail, middle rail and the bottom rail are all made of plastic and are tubular, which is convenient to adjust the lengths of the rails by cutting the pipe off with knife.

### BACKGROUND OF THE INVENTION

1. Field of the Invention

The present invention relates to a window covering device, and particularly relates to a window covering device that is capable of spreading and folding from bottom or from top, and is mounted at window or French window to adjust the indoor brightness.

2. Description of the Related Art

Window covering device is necessary as a part of a room nowadays. A conventional window covering device is normally opened and closed horizontally or vertically.

The conventional window covering device above normally includes a top rail with cords and a cord controller, a window covering is connected to a bottom of the top rail, and a bottom rail is mounted at the bottom of the window covering. The top rail is mounted at a top edge of a window, and the cords are able to control the bottom rail by the cord controller. The bottom rail brings the window covering to be spread or to be folded. However, the window covering is fixed on the top rail, so the window covering is only opened from bottom.

Another kind of window covering device is opened or closed from top or bottom, which includes a top rail, a middle rail and a bottom rail. A window covering is connected between the middle rail and the bottom rail. Two cord controllers are provided at two ends of the top rail, and two cords are mounted respectively through the cord controllers. One cord is connected with the middle rail, and the other cord is connected with the bottom rail through the top rail and the window covering. When the window covering device is mounted on the window, the bottom rail is controlled to descend or rise by one cord, in addition, the middle rail is controlled to descend or rise by the other cord, thus the window covering device is opened either from top or from bottom.

However, the window covering device in the market are normalized products, and not necessarily accord with different windows, so the rails have to be cut sometimes, which needs electric saw, and brings a lot of inconvenience.

Therefore, the invention provides a window covering device to mitigate or obviate the aforementioned problems.

### SUMMARY OF THE INVENTION

The main objective of the present invention is to provide a window covering device that is capable of spreading and folding from bottom or from top, and is mounted at window or French window to adjust the indoor brightness.

A window covering device includes a top rail, a middle rail, and a bottom rail. A window covering is connected to the middle rail and the bottom rail. Multiple roller groups are mounted in the top rail. Two cord controllers are mounted on the top rail, as well as two cord groups. Each cord group includes inner cords and outer cords. One of the inner cords winds the rollers and is mounted on the middle rail through the top rail and the other inner cord winds the rollers and is mounted on the bottom rail through the top rail, the middle rail and the window covering.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the window covering device in accordance with the present invention spreading fully;

FIG. 2 is a perspective view in partial section of the cut-away top rail of the window covering device in FIG. 1;

FIG. 3 is a top view in partial section of the cut-away top rail of the window covering device in FIG. 2;

FIG. 4 is a side view in partial section of the cord controller of the window covering device in FIG. 3;

FIG. 5 is an enlarged top view in partial section of the cord controller of the window covering device in FIG. 3; and

FIG. 6 is an operational perspective view of the window covering device in FIG. 1 with the middle rail descending.

### DETAILED DESCRIPTION OF THE PREFERRED EMBODIMENT

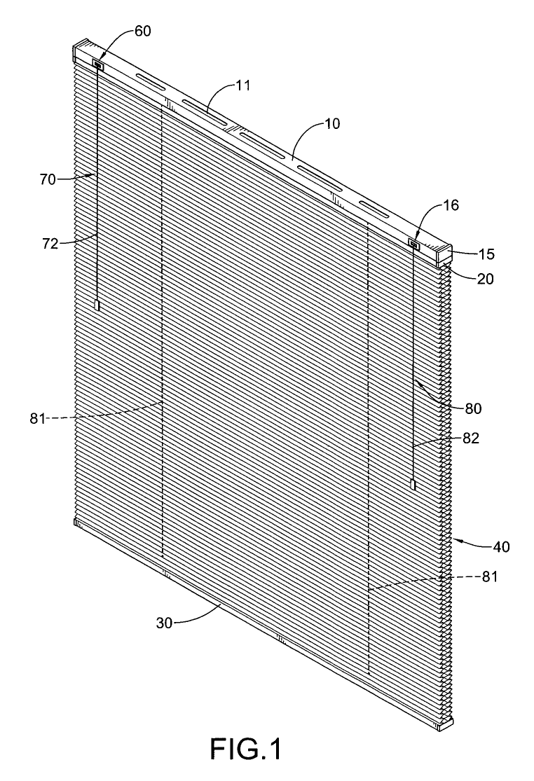

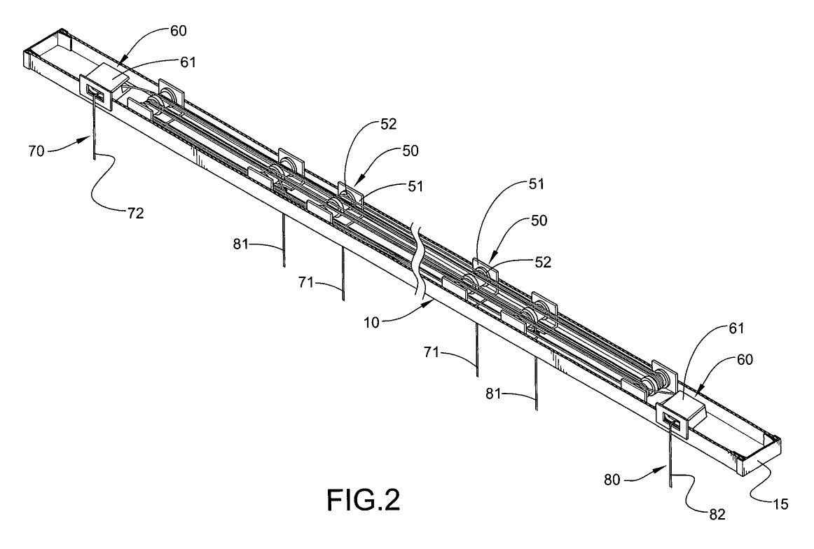

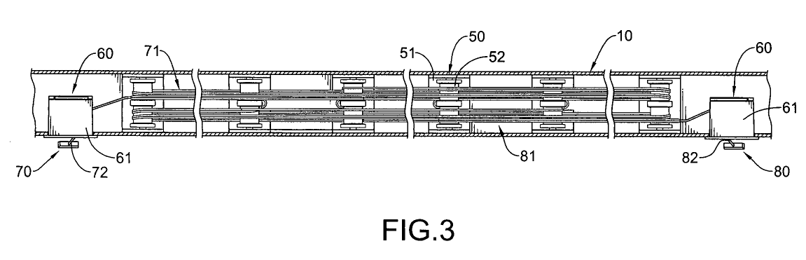

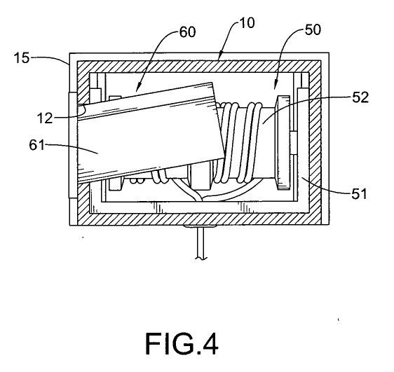

With reference to FIGS. 1-4, a window covering device in accordance with the present invention has a top rail (10), a middle rail (20), a bottom rail (30), a window covering (40), multiple roller groups (50), two cord controllers (60), a middle cord group (70), and a bottom cord group (80).

The top rail (10) is made of plastic, is hollow and tubular and has a top, a bottom, a front, a back, two ends, at least one longitudinal hole (11) defined in the top, two mounting holes (12) defined in the front near the ends, and two inner through holes and two outer through holes defined in the bottom near the ends. Two end caps (15) are mounted in the two ends of the top rail (10).

The middle rail (20) is made of plastic, is hollow and tubular, and is mounted movably below the top rail (10).

The bottom rail (30) is located under the middle rail (20), is made of plastic and is tubular.

The window covering (40) is connected to the middle rail (20) and the bottom rail (30) and is located between the middle rail (20) and the bottom rail (30).

The multiple roller groups (50) are mounted in the top rail (10) between the two mounting holes (12). Each of the multiple roller groups (50) includes a roller seat (51) mounted securely in the top rail (10) and a first roller (52) mounted rotatably on the roller seat (51). The location of the roller groups (50) can be adjusted through the at least one longitudinal hole (11). In this preferred embodiment, six roller groups (50) are mounted in the top rail (10).

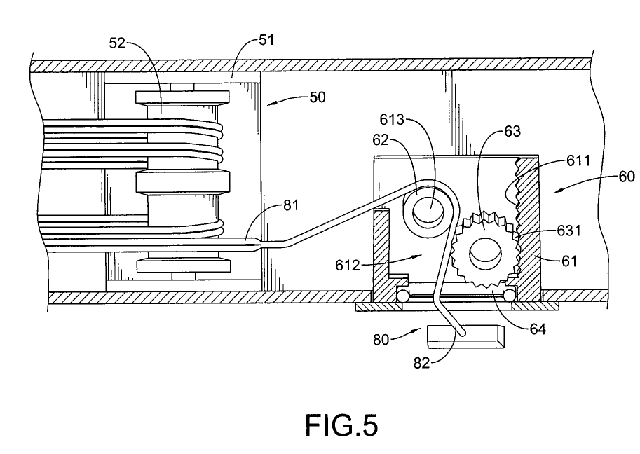

With further reference to FIG. 5, the two cord controllers (60) are mounted respectively in two mounting holes (12) in the top rail (10) and each includes a location seat (61), a second roller (62), and a brake wheel (63). The location seat (61) is mounted in the mounting hole (12) in the top rail (10) and has a chamber (612) defined therein. A front port and a back port of the location seat (61) communicate with the chamber (612). A tooth portion (611) is formed in an inner surface of the chamber (612) near one end of the top rail (10). A pole (613) is provided at the back port at a distance from the tooth portion (611). The second roller (62) has an axle hole defined in the second roller (62), and is mounted rotatably on the pole (613) at a distance from the tooth portion (611). The brake wheel (63) is mounted movably in the chamber (612). An outer edge of the brake wheel (63) has a gear portion (631) engaged with the tooth portion (611).

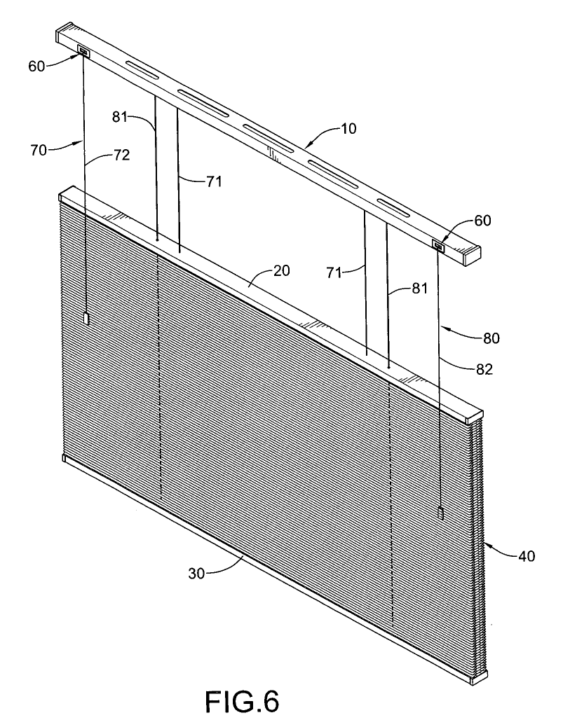

The middle cord group (70) is mounted through one of the cord controllers (60) and includes two middle inner cords (71) and a middle outer cords (72) connected to one end of each middle inner cord (71) directly or indirectly. The middle inner cords (71) wind the roller groups (50), are mounted through the inner through holes in the bottom of the top rail (10) and are connected to two ends of the middle rail (20), as shown in FIG. 6. The middle outer cord (72) is mounted through and extends out from one of the cord controllers (60).

The bottom cord group (80) is mounted in the other controller (60) on the top rail (60), is mounted on the bottom rail (30) through the bottom of the top rail (60), the middle rail (20) ant the window covering (40). The bottom cord group (80) includes two bottom inner cords (81) and a bottom outer cord (82) connected to one end of each bottom inner cord (81) directly or indirectly. The bottom inner cords (81) wind the roller groups (50), are mounted respectively through the outer through holes in the bottom of the top rail (10), are mounted movably through the middle rail (20) and the window covering (40), and are mounted securely on the bottom rail (30). The bottom outer cord (82) is mounted through and extends out from the other cord controller (60).

Each of the two cord controllers (60) has a smooth contact (64) mounted in the front port and having a smooth surface smoothly contacting one of the middle and bottom cord groups (70), (80).

When the window covering device is applied on the window or French window, the top rail (10) is mounted on a top edge of the window, as shown in FIGS. 1-4. The bottom outer cord (82) is pulled to escape the catch of the second roller (62) and the brake wheel (63), and release or pull the two bottom inner cords (81), so that the window covering (40) is spread out or is folded. When the bottom rail (30) is needed to stay at a certain level, the weight of the bottom rail will bring the bottom outer cord (82) to move backward, and the brake wheel (63) is driven to roll backward, along the tooth portion (611), and the brake wheel (63) and the second roller (62) catch the cord (82).

When the middle outer cords (72) are pulled to escape the catch of the second roller (62) and the break wheel (63), and release or pull the two middle inner cords (71), the middle rail (20) is brought to descend or rise, as shown in FIG. 6. An upper part of the window covering (40) is brought to descend or rise when the middle rail (20) is needed to stay at a certain level. The weight of the middle rail (20) will bring the middle outer cord (72) to move backward, and the brake wheel (63) is brought to move backward along the tooth portion (611), and the brake wheel (63) and the second roller (62) catch the cord (72).

The middle and bottom cord groups (70, 80) may be used to change the levels of the middle rail (20) and the bottom rail (30) so a vertical location of the window covering (40) may be adjusted conveniently and spread or fold of the window covering (40) may be implemented quickly. Furthermore, the top rail (10), middle rail (20) and the bottom rail (30) are all made of plastic and are tubular, which is convenient to adjust the lengths of the rails (10, 20, 30) by cutting the pipe off with knife.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A window covering device comprising a top rail, a middle rail, a bottom rail, a window covering, multiple roller groups, two cord controllers, a middle cord group and a bottom cord group, wherein
the top rail has a top, a bottom, a front and two ends;
the window covering is connected to the middle rail and the bottom rail and is located between the middle rail and the bottom rail;
the roller groups is mounted in the top rail, the two cord controllers respectively mounted in the top rail;
the middle cord group is mounted through one of the cord controllers, winds the roller groups, and is mounted on the middle rail through the bottom of the top rail;
the bottom cord group is mounted in the other cord controller, winds the roller groups, is mounted on the bottom rail through the bottom of the top rail, the middle rail and the window covering;
the top rail, middle rail, and bottom rail are all made of plastic and are tubular, the top rail has at least a longitudinal hole defined in the top, two mounting holes are defined in the front near the ends;
the middle cord group includes two middle inner cords and a middle outer cord connected to one end of each middle inner cord, the middle inner cords wind the roller groups, are mounted through the bottom of the top rail and are connected to two ends of the middle rail, the middle outer cord is mounted through extends out from one of the cord controllers;
the bottom cord group includes two bottom inner cords and a bottom outer cord connected to one end of each bottom inner cord, the bottom inner cords wind the roller groups, are mounted through the bottom of the top rail, are mounted movably through the middle rail, the window covering and are mounted securely on the bottom rail, the bottom outer cord is mounted through and extends out from the other cord controller.

2. The window covering device as claimed in claim 1, wherein the cord controllers each has a location seat, a second roller and a brake wheel, the location seat is mounted in the mounting hole in the top rail and has a chamber defined therein, a front port and a back port of the location seat communicate with the chamber, a tooth portion is formed in an inner surface of chamber near one end of the top rail, and the second roller is mounted rotatably in the back port at a distance from the tooth portion, and the brake wheel is mounted movably in the chamber, an outer edge of the brake wheel has a gear portion engaged with the tooth portion.

3. The window covering device as claimed in claim 1, wherein the each of the cord controllers has a smooth contact mounted in the front port and having a smooth surface smoothly contacting one of the middle and bottom cord groups.
